(19) United States
(12) Patent Application Publication
(10) Pub. No.: US 2002/0089841 A1
(43) Pub. Date: Jul. 11, 2002

(54) Electronic luminscence displaying device

(76) Inventor: Juses Chao, Taipei Hsien (TW)

Correspondence Address: Rosenberg, Klein & Lee, Suite 101, 3458 Ellicott Center Drive, Ellicott City, MD, 21043, US

(21) Appl. No.: 09/754,316

(22) Filed: Jan. 5, 2001

(51) Int. Cl. F21V 9/16

(52) U.S. Cl. 362/84; 362/231; 362/240

(57) ABSTRACT

An electronic luminscence unit includes a substrate, a plurality of electronic luminscence unit and a transparent plate. Each electronic luminscence unit is arranged on the substrate. Each electronic luminscence unit has a circle as a grounding end. The portions near the grounding end are circlarly installed with a red light portion (R), a green light portion (G), and a blue light portion (B) with a ratio of 1:2:7, respectively and a space is formed therebetween. The light portions of the grounding end are connected to a driving device for boosting the input voltage and doubling the frequency to the electronic luminscence unit so as to achieve a required illumination and acquire a desired light color. The transparent plate is installed above the substrate. A transmitting hole with an elliptic shape or a taper shape is installed on the electronic luminscence unit so that the light from the electronic luminscence unit can be projected out from the respective transmitting hole and then mixed. Therefore, in application (to an advertisement board), all colors can be presented.

### FIELD OF THE INVENTION

The present invention relates to an electronic luminscence displaying device, and especially to an electronic luminscence plate presenting all colors.

### BACKGROUND OF THE INVENTION

An electronic luminscence unit is a device for lighting in normal temperature by converting electric energy.

The conventional electronic luminscence unit has the following disadvantages so that it can not be widely sued. The defects are:

1. A small size with a maximum of A4 size due to the yield ratio of the electronic luminscence material.

2. The electronic luminscence unit has an insufficent illumination (below 100 lumens).

3. The conventional electronic luminscence unit is a single color device.

Therefore, the conventional electronic luminscence unit is not suitable to be used to an advertisement board and can not present all various colors.

### SUMMARY OF THE INVENTION

Accordingly, the primary object of the present invention is to provide an electronic luminscence unit including a substrate, a plurality of electronic luminscence unit and a transparent plate. Each electronic luminscence unit is arranged on the substrate. Each electronic luminscence unit has a circle as a grounding end. The portions near the grounding end is circularly installed with a red light portion (R), a green light portion (G), and a blue light portion (B) with a ratio of 1:2:7, respectively and a space is formed therebetween. The light portions of the grounding end are connected to a driving device for boosting the input power source and doubling the frequency to the electronic luminscence unit so as to achieve a required illumination and acquire a desired light color. The transparent plate is installed above the substrate. A transmitting hole with an elliptic shape or a taper shape is installed on the electronic luminscence unit so that the light from the electronic luminscence unit can be projected out from the respective transmitting hole and then mixed.

Another object of the present invention is to provide a electronic luminscence displaying device, thereby, in applying to an advertisement board (a large area), all colors can be presented.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is a cross sectional view of the present invention.

FIG. 3 is a cross sectional view of another embodiment of the present invention.

FIG. 4 is a perspective view of an electronic luminscence unit according to the present invention.

FIG. 5 is another perspective view of an electronic luminscence unit of the present invention.

### DETAILED DESCRIPTION OF THE PREFERRED EMBODIMENTS

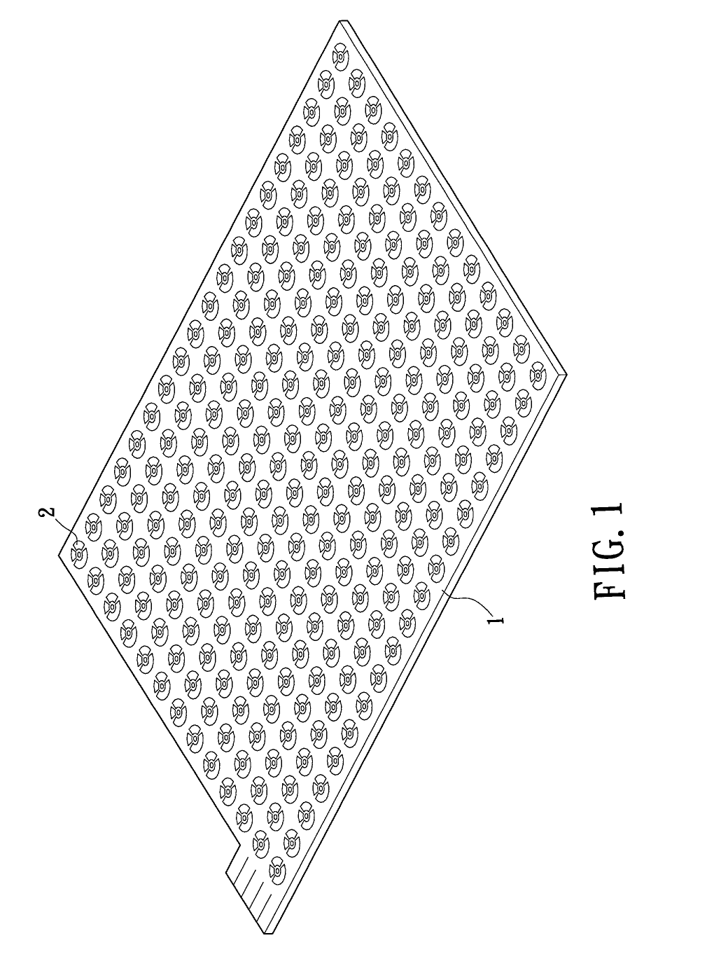

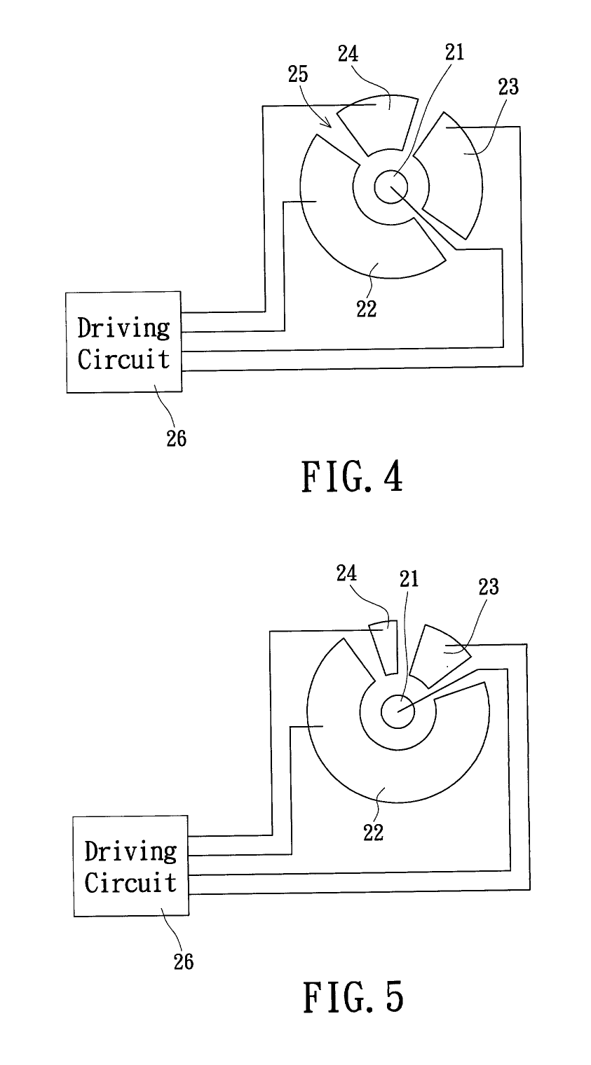

Referring to FIGS. 1 to 4, the electronic luminscence displaying device of the present invention is illustrated. The electronic luminscence unit 2 includes a substrate 1, a plurality of electronic luminscence unit 2 and a transparent plate 3.

The substrate is a fiber enhancing resin plate, a ceramic substrate, or a polysilicon plate or others having the same function.

Each electronic luminscence unit 2 is arranged on the substrate 1 by screen printing. Each electronic luminscence unit 2 has a circle as a grounding end 21. The portions near the grounding end 21 is circularly installed with a red light portion (R) 22, a green light portion (G) 23, and a blue light portion (B) 24 with a ratio of 1:2:7, respectively and a space 25 is formed therebetween. The light portions 22, 23 and 24 are connected to a driving device 26 for boosting the input voltage and doubling the frequency to the electronic luminscence unit 2 so as to achieve a required illumination and acquire a desired light color.

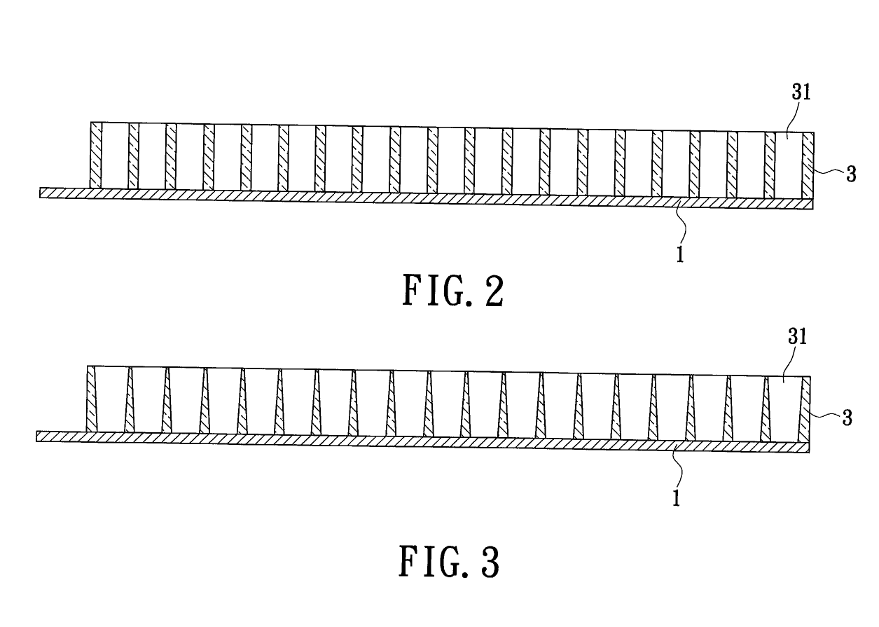

The transparent plate 3 is installed above the substrate 1. A transmitting hole 31 with an elliptic shape (FIG. 2) or a tapered shape (FIG. 3) is installed on the electronic luminscence unit 2 so that the light from the electronic luminscence unit 2 can be projected out from the respective transmitting hole and then mixed.

Therefore, in application (to an advertisement board), all colors can be presented.

With reference to FIG. 5, the red light portion (R) 22, green light portion (G) 23, and blue light portion (B) 24 may have a ratio of 0.5˜2:1˜3:5˜8.5, respectively for presenting various colors.

In summary, the present invention has the following advantages:

1. All colors can be presented.

2. The cost is reduced greatly.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An electronic luminscence displaying device comprising:
a substrate; and
a plurality of electronic luminscence unit being arranged on the substrate; each electronic luminscence unit having a circle as a grounding end; portions adjacent to the grounding end being circularly installed with light portions of different ratios; adjacent two light portions having a spacing therebetween; each light portion and the grounding end being connected to a driving circuit for boosting an input voltage and doubling a frequency inputted to the electronic luminscence unit for obtaining a required illumination and color.

2. The electronic luminscence unit as claimed in claim 1, wherein a ratio of the light portions is 1:2:7.

3. The electronic luminscence unit as claimed in claim 1, wherein colors of the light portions are red, blue, and green.

4. The electronic luminscence unit as claimed in claim 1, wherein a ratio of the first light portion is 0.5˜2.0.

5. The electronic luminscence unit as claimed in claim 1, wherein a ratio of the second light portion is 1˜3.0.

6. The electronic luminscence unit as claimed in claim 1, wherein a ratio of the third light portion is 5˜8.5.

7. The electronic luminscence unit as claimed in claim 1, wherein the transparent plate is installed above the substrate; a transmitting hole is installed on the electronic luminscence unit so that the light from the electronic luminscence unit is projected out from the respective transmitting hole and then mixed.

8. The electronic luminscence unit as claimed in claim 7, wherein the transmitting hole has an elliptical shape.

9. The electronic luminscence unit as claimed in claim 7, wherein the transmitting hole has a tapered shape.
